(19) United States
(12) Patent Application Publication
(10) Pub. No.: US 2008/0266068 A1
(43) Pub. Date: Oct. 30, 2008

(54) Remote Signal Communication System Having Improved Reception Performance

(75) Inventors: Brian J. Farrell, Troy, MI (US); Jean-Christophe Deniau, Fenton, MI (US); John R. Costello, Rochester Hills, MI (US)

Correspondence Address: CARLSON, GASKEY & OLDS, P.C., 400 WEST MAPLE ROAD, SUITE 350, BIRMINGHAM, MI, 48009, US

(73) Assignee: Continental Automotive Systems US, Inc., Auburn Hills, MI (US)

(21) Appl. No.: 12/047,343

(22) Filed: Mar. 13, 2008

Related U.S. Application Data
(60) Provisional application No. 60/926,665, filed on Apr. 27, 2007.

(51) Int. Cl. B60R 27/00

(52) U.S. Cl. 340/426.17

(57) ABSTRACT

A method for improving the reception performance of a remote signal communication system includes communicating a signal from a proximate communication device to an electronic control module, communicating a first portion of the signal to a first input capture of the electronic control module, and communicating a second portion of the signal to a second input capture of the electronic control module.

### CROSS-REFERENCE TO RELATED APPLICATIONS

This application claims priority to U.S. Provisional Patent Application No. 60/926,665, filed Apr. 27, 2007.

### BACKGROUND OF THE INVENTION

This disclosure relates generally to a remote signal communication system, and more particularly to a method for improving the reception performance of a remote signal communication system.

A variety of remote signal communication systems are used in vehicles to authorize and perform desired functions remotely. Examples include remote keyless entry systems (RKE), passive start and entry systems (PASE), and tire pressure monitoring systems (TPMS). Functions performed by these systems include, for example, unlocking and locking of vehicle doors, enabling the vehicle starting system without a mechanical key, and monitoring the tire pressure of the vehicle tires.

In a RKE system, for example, a radio frequency (RF) transmitter located within a key fob transmits a RF signal to a RF receiver located within an electronic control module mounted on the vehicle. Based on the signals received by the RF receiver, the electronic control module grants ingress to the various ports of the vehicle.

One disadvantage of remote signal communication systems that communicate via RF signals is that the RF signals are susceptible to numerous noise spikes during their transmission. Noise spikes can cause the RF data to be received and interpreted incorrectly by the electronic control module. Noise spikes typically occur where a weakened signal is received by the RF receiver from the RF transmitter, or where RF signals are received in an environment that contains a high level of RF noise.

Disadvantageously, failure to properly filter the noise spikes from the transmitted RF signals may cause the noise spike to be interpreted as valid data. Known noise filters incorporated into the remote signal communication systems have not adequately alleviated these problems.

Accordingly, it is desirable to provide a remote signal communication system capable of adequately filtering noise spikes that may occur within a RF signal, and that provides increased reception performance.

### SUMMARY OF THE INVENTION

A method for improving the reception performance of a remote signal communication system includes communicating a signal from a proximate communication device to an electronic control module, communicating a first portion of the signal to a first input capture of the electronic control module, and communicating a second portion of the signal to a second input capture of the electronic control module.

A remote signal communication system includes a proximate communication device and an electronic control module. The proximate communication device includes a signal transmitter. The electronic control module includes a signal receiver and a microcontroller. The signal receiver communicates a signal received from the proximate communication device to the microcontroller through each of a first input capture and a second input capture.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic representation of an example remote signal communication system;

FIG. 2 illustrates a data stream of a signal communicated by the remote signal communication system illustrated in FIG. 1;

FIG. 3 illustrates an example electronic control module of the example remote signal communication system illustrated in FIG. 1;

FIG. 4 illustrates input captures of the example electronic control module illustrated in FIG. 3;

FIG. 5 illustrates an example method for improving the reception performance of a remote signal communication system; and

FIG. 6 graphically illustrates the timing of a rising edge data and falling edge data of a signal communicated by the example remote signal communication device illustrated in FIG. 1.

### DETAILED DESCRIPTION OF THE DISCLOSED EMBODIMENT

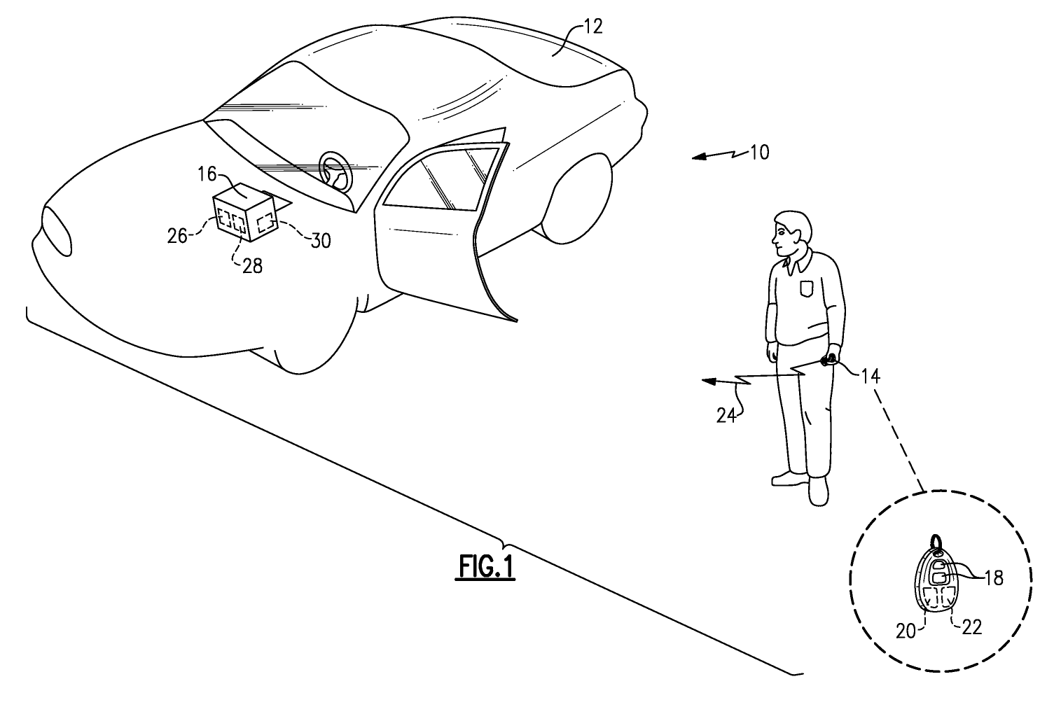

FIG. 1 illustrates an example remote signal communication system 10 of a vehicle 12. In one example, the remote signal communication system 10 includes a remote keyless entry (RKE) system. In another example, the remote signal communication system 10 includes a passive start and entry system (PASE). In yet another example, the remote signal communication system 10 includes a tire pressure monitoring system (TPMS). It should be understood that the vehicle 12 may be equipped with any combination of remote signal communication systems, and that the disclosed examples presented herein are applicable to any remote signal communication system.

The remote signal communication system 10 includes a proximate communication device 14 and an electronic control module (ECM) 16. In one example, the proximate communication device 14 is a key fob. Although only one proximate communication device 14 is illustrated, it should be understood that a plurality of proximate communication devices 14 could be associated with the remote signal communication system 10.

The proximate communication device 14 includes a plurality of switches 18, a signal transmitter 20 and an encoder 22. The switches 18 are manipulated to communicate a signal 24 from the proximate communication device 14 to the electronic control module 16. In one example, the signal 24 is a radio frequency (RF) signal. The signal 24 includes instructions for commanding the performance of various vehicle commands/functions, such as unlocking/locking a vehicle door, opening a trunk, and the like.

The proximate communication device 14 communicates the signal 24 via the signal transmitter 20. In one example, the signal transmitter 20 is an RF transmitter. Prior to communication of the signal 24, the encoder 22 encodes the signal 24 to provide a simplified signal to the electronic control module 16 for processing. In one example, the encoder 22 is a Manchester encoder capable of performing Manchester coding of the signal 24.

The electronic control module 16 includes a signal receiver 26, a decoder 28, and a microcontroller 30. The signal receiver 26 receives the signal 24 and communicates the signal 24 to the microcontroller 30 for further processing. Once received by the microcontroller 30, the signal is decoded by the decoder 28, for example. For example, the microcontroller 30 may determine whether the signal 24 represents a valid signal, and actuate a vehicle system in response to the valid signal.

FIG. 2 illustrates the signal 24 that is communicated from the signal receiver 26 to the microcontroller 30 for processing. The signal 24 is a data stream that can be interpreted as binary data. The binary data includes a plurality of bits of information that instruct the microcontroller 30. The signal 24 also includes a plurality of rising edge data 34 and a plurality of falling edge data 36. The rising edge data 34 and the falling edge data 36 must be filtered to determine whether the signal 24 represents a valid data signal, or whether the signal 24 can be ignored as noise. The example remote signal communication system 10 is operable to filter the noise in the signal 24, as is further discussed below.

FIG. 3 illustrates the example electronic control module 16 of the remote signal communication system 10. The electronic control module 16 includes the signal receiver 26, the decoder 28, and the microcontroller 30. The signal 24 is communicated between the signal receiver 26 and the microcontroller 30 through a first input capture 38 and a second input capture 40. In one example, the rising edge data 34 of the signal 24 is communicated to the first input capture 38, and the falling edge data 36 of the signal 24 is communicated through the second input capture 40. That is, the rising edge data 34 and the falling edge data 36 are communicated through the microcontroller over separate inputs for independent processing by the microcontroller 30.

Two separate input captures 38, 40 are utilized because of the interrupt latency associated with the microcontroller 30. Interrupt latency represents an amount of time that the remote signal communication system 10 waits on the microcontroller 30 to analyze and process the signal 24. There is always an interrupt latency associated with the remote signal communication system 10. The interrupt latency varies depending on what type of task the microcontroller 30 was handling when the interrupt occurred.

In one example, the microcontroller 30 is interrupted in response to receiving rising edge data 34. If only a single input capture is included on the microcontroller 30, the falling edge data 36 could be missed. Missed falling edge data 36 may cause the microcontroller 30 to interpret a noise spike as valid data, leading to an incorrectly decoded signal 24.

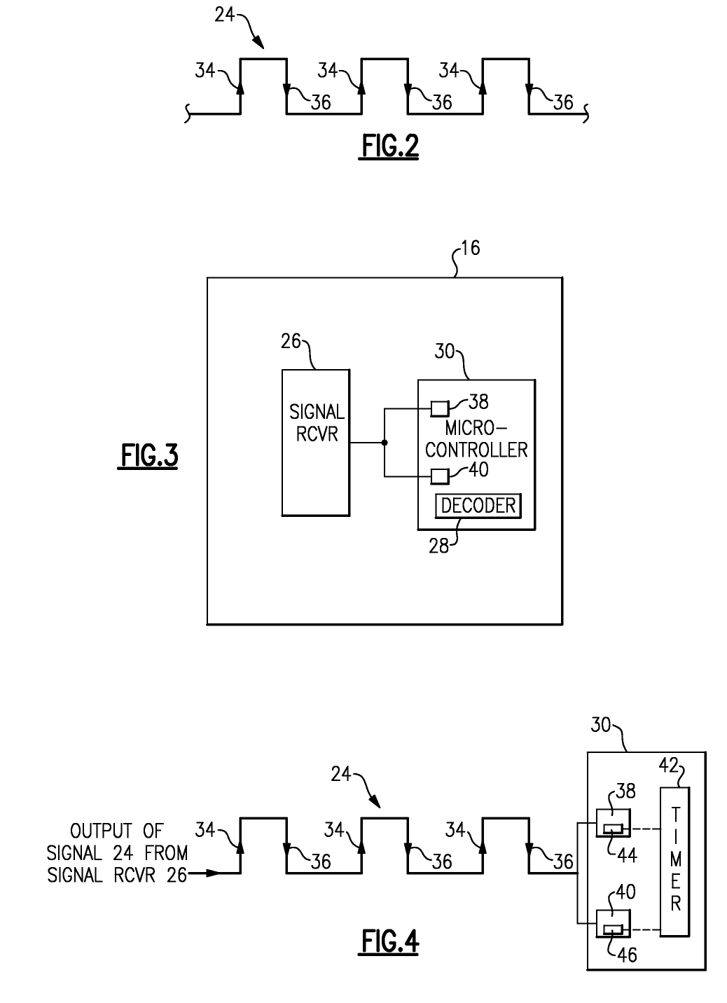

Referring to FIG. 4, the microcontroller 30 includes a free running timer 42, a first time stamp register 44, and a second time stamp register 46. Both the rising edge data 34 and the falling edge data 36 are communicated over the first input capture 38 and the second input capture 40, respectively, to the free running timer 42. The free running timer 42 times when the rising edge data 34 occurs, and stores the rising edge data time within the first time stamp register 44. Likewise, the falling edge data 36 is timed by the free running timer 42, and a time associated with the falling edge data 36 is stored in the second time stamp register 46. A duration between the rising edge data 34 and the falling edge data 36 may be calculated by the microcontroller 30 based upon the times stored in the time stamp registers 44, 46 to authenticate the rising edge data 34, as is further discussed below with respect to the method 100.

FIG. 5, with continuing reference to FIGS. 1-4, illustrates a method 100 for improving the reception performance of a remote signal communication system 10. The method begins at step block 102, where a signal 24 is communicated from a proximate communication device 14 to an electronic control module 16. In one example, the signal 24 includes RF signals. The signal 24 is encoded by the encoder 22 and communicated to the electronic control module 16 via the signal transmitter 20. The electronic control module 16 receives the signal 24 with the signal receiver 26.

Next, at step block 104, the signal 24 is communicated from the signal receiver 26 to the microcontroller 30 via the first input capture 38 and the second input capture 40. In one example, only rising edge data 34 is communicated over the first input capture 38, and only the falling edge data 36 is communicated over the second input capture 40. At step block 106, the rising edge data 34 and the falling edge data 36 are timed by the free running timer 42, and each time is stored with the time stamp registers 44, 46.

At step block 108, the microcontroller 30 calculates a duration between the time stored within the second time stamp register 46 and the time stored within the first time stamp register 44. That is, the time associated with the falling edge data 36 is subtracted from the time associated with the rising edge data 34 to calculate the duration between a detected rising edge data 34 and a detected falling edge data 36. Each of step blocks 102 through 108 are repeated for each rising edge 34 and falling edge 36 that occur within the signal 24 at step block 110.

Finally, at step block 112, and in response to the duration exceeding a minimum duration stored within the microcontroller 30, the rising edge data 34 is considered valid data and the signal 24 is communicated to the decoder 28 to determine what type of data the signal 24 represents. In one example, the minimum duration is based upon the data rate of the remote signal communication system 10.

In another example, the minimum duration is 500 micro-seconds (ms). If the duration fails to exceed the minimum duration stored in the microcontroller 30, the data is ignored as noise.

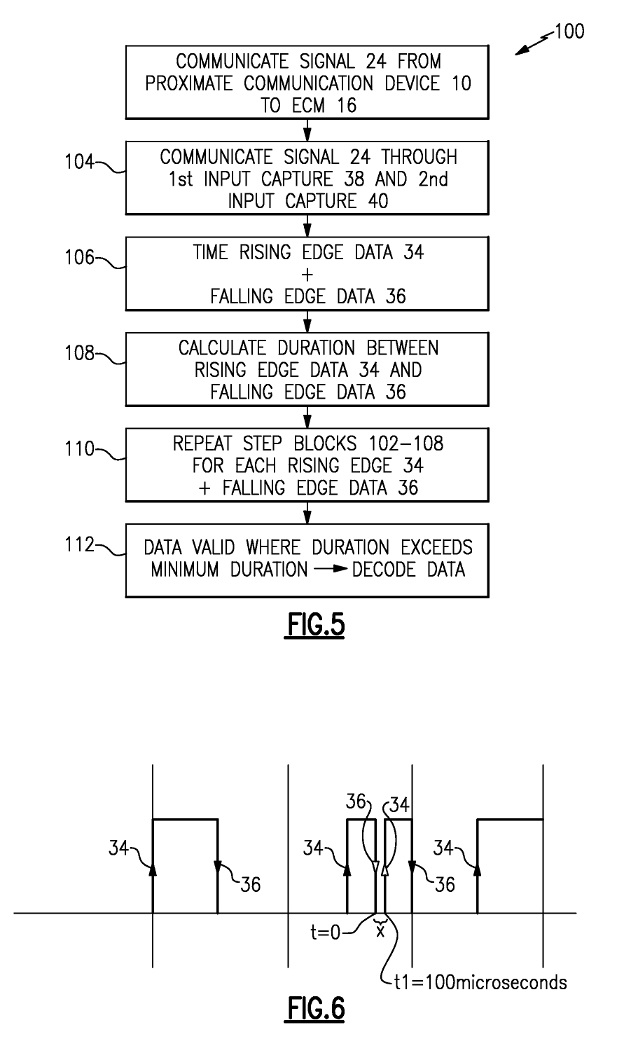

FIG. 6 is a graphical illustration of the timing of the rising edge data 34 and the falling edge data 36. In this example, rising edge data 34 is detected at time t=0. The microcontroller 30 is interrupted at this time to begin processing the signal 24. Falling edge data 36 is next detected at time t=100 ms. Therefore, the duration X between the rising edge data 34 and the falling edge data 36 is 100 ms. Where the remote signal communication device has a stored minimum duration of 500 ms, the microcontroller 30 ignores the rising edge data 34 as noise because the duration X fails to exceed the predefined minimum duration.

The example remote signal communication system 10 achieves improved reception performance through the use of two separate input captures 38, 40. The use of the two input captures 38, 40 allows for increased range for receiving and interpreting signals at the sensitivity limit of the remote signal communication device 10, and provides improved reception of the signals in relatively noisy environments.

The foregoing description shall be interpreted as illustrative and not in any limiting sense. A worker of ordinary skill in the art would understand that certain modifications would come within the scope of this disclosure. For these reasons, the following claims should be studied to determine the true scope and content of the disclosure.

What is claimed is:

1. A method for improving the reception performance of a remote signal communication system having a proximate communication device and an electronic control module, comprising the steps of:
a) communicating a signal from the proximate communication device to the electronic control module;
b) communicating a first portion of the signal to a first input capture of the electronic control module; and
c) communicating a second portion of the signal to a second input capture of the electronic control module.

2. The method as recited in claim 1, wherein the signal includes RF data, and the first portion of the RF data includes rising edge data and the second portion of the RF data includes falling edge data.

3. The method as recited in claim 1, wherein said step a) includes the steps of:
encoding the signal communicated from the proximate communication device;
communicating the encoded signal to the electronic control module;
decoding the encoded signal; and
communicating the first portion of the signal to the first input capture and the second portion of the signal to the second input capture.

4. The method as recited in claim 1, wherein said step b) includes the steps of:
communicating the first portion of the signal to a free running timer; and
storing a time associated with the first portion of the signal in a time stamp register.

5. The method as recited in claim 4, wherein said step c) includes the steps of:
communicating the second portion of the signal to the free running timer; and
storing a time associated with the second portion of the signal in a second time stamp register that is different from the time stamp register.

6. The method as recited in claim 5, comprising the step of:
d) comparing a duration between the time stored for the second portion of the signal and the time stored for the first portion of the signal to a minimum duration to filter and authenticate the signal.

7. The method as recited in claim 6, wherein said step d) includes the step of:
subtracting the time stored for the first portion from the time stored for the second portion to calculate the duration; and
ignoring the duration as noise in response to the duration failing to exceed the minimum duration.

8. The method as recited in claim 6, wherein the minimum duration is equal to a data rate associated with the remote signal communication system.

9. The method as recited in claim 1, comprising the step of:
d) comparing a duration between the first portion of the signal and the second portion of the signal to a minimum duration to authenticate the signal.

10. The method as recited in claim 9, comprising the step of:
e) repeating said steps a) through d) for each rising edge data and falling edge data that occur within the signal.

11. The method as recited in claim 10, comprising the step of:
f) actuating a vehicle system associated with the remote signal communication system in response to the duration exceeding the minimum duration.

12. The method as recited in claim 9, comprising the step of:
e) ignoring the duration as noise in response to the duration failing to exceed the minimum duration.

13. A remote signal communication system, comprising:
a proximate communication device having a signal transmitter; and
an electronic control module having a signal receiver and a microcontroller, wherein said signal receiver communicates said signal received from said proximate communication device to said microcontroller through each of a first input capture and a second input capture.

14. The system as recited in claim 13, wherein said signal includes RF data having rising edge data and falling edge data.

15. The system as recited in claim 14, wherein one of said first input capture and said second input capture receives said rising edge data and the other of said first input capture and said second input capture receives said falling edge data.

16. The system as recited in claim 13, wherein said microcontroller includes a free running timer, a first time stamp register, and a second time stamp register.

17. The system as recited in claim 16, wherein said first time stamp register stores a time when each rising edge data occurs, and said second time stamp register stores a time when each falling edge data occurs.

18. The system as recited in claim 13, wherein said signal transmitter includes an encoder, and said signal receiver includes a decoder.
